(19) United States
(12) Patent Application Publication
(10) Pub. No.: US 2016/0054592 A1
(43) Pub. Date: Feb. 25, 2016

(54) CONTAINER-OPENING EYEWEAR

(71) Applicant: Hip Visions, LLC, Fishkill, NY (US)

(72) Inventor: Robert Philip Ianelli, Hopewell Junction, NY (US)

(21) Appl. No.: 14/833,318

(22) Filed: Aug. 24, 2015

Related U.S. Application Data
(60) Provisional application No. 62/041,387, filed on Aug. 25, 2014.

(51) Int. Cl. G02C 11/00; G02C 5/14

(52) U.S. Cl. CPC G02C 11/00; G02C 5/146; G02C 5/143

(57) ABSTRACT

An apparatus includes an eyeglass frame having a lens holder configured to support an eyeglass lens, a temple support having a first end configured to attach to the lens holder and a second end configured to be affixed to a wearers head; and a piercing member positioned on the eyeglass frame.

### CROSS REFERENCE TO RELATED APPLICATIONS

This application claims priority to U.S. Provisional Application No. 62/041,387, filed on Aug. 25, 2014, the contents of which are hereby incorporated by reference in their entirety.

### BACKGROUND

The term “shotgunning” relates to a way to consume a beverage (e.g., beer) very quickly by puncturing a hole in the side of the beverage can. This technique causes the liquid from the can to exit quickly because to release pressure the air entering the can must travel through the same orifice as the liquid leaving. The extra hole created by punching the hole in the side of the can allows air to enter simultaneously as the liquid leaves the punctured hole and into the drinker's mouth.

For example, to shotgun a beverage, a small hole is punched in the side of the can, close to the bottom of the can. To prevent the liquid from spilling out while the cut is being made, the can is held horizontally and tilted slightly toward the end of the can with the drinking spout to create an air pocket at the bottom of the can. The hole is then punched in the resulting air pocket. The hole is typically made with a sharp or pointed object (e.g., a key, bottle opener, knife, other sharp instrument). Once the hole has been punched, the drinker places their mouth over the drinking spout. The drinker can draw suction over the punched hole while rotating the can straight up. When the ring-tab of the can is pulled, the liquid will quickly drain through the punched hole into the drinker's mouth.

### SUMMARY

In a general aspect of the invention, an apparatus includes an eyeglass frame, having a lens holder configured to support an eyeglass lens; a temple support having a first end configured to attach to the lens holder and a second end configured to be affixed to a wearers head; and a piercing member positioned on the eyeglass frame.

Embodiments of this aspect of the invention may include one or more of the following features. The piercing element is attached to the lens holder at a region proximate to an attachment region between the lens holder and temple support. The piercing element includes a square-based pyramid shape with a point. Alternatively, the piercing element has a triangular shape with a point. The piercing element is attached to the lens holder at the second end of the temple support. The piercing element is integrally formed on the eyeglass frame.

In another aspect of the invention, a method of making eyeglasses includes providing an eyeglass frame, including a lens holder configured to support an eyeglass lens, a temple support having a first end configured to attach to the lens holder and a second end configured to be affixed to a wearers head; and attaching a piercing member on the eyeglass frame.

Embodiments of this aspect of the invention may include one or more of the following features. Attaching the piercing element includes attaching the piercing element to the lens holder at a region proximate to an attachment region between the lens holder and temple support. The piercing element includes a square-based pyramid shape or a triangular shape with a point. The piercing element is attached at the second end of the temple support. The piercing element is provided integrally with the eyeglass frame.

Among other advantages, the eyewear is configured to facilitate the rapid consumption of a canned beverage. This is accomplished by using the piercing element to pierce a hole in the side of a drink container (e.g. aluminum can). Once a hole is made, the user puts his/her mouth up to he/she hole they have just created, holding the can upright, and opening the top regularly, thus allowing the beverage to be consumed in a process referred to as “shotgunning.”

The shape and size of the piercing element can vary depending on the location of the piercing element on the glasses. While varied, the placement of the piercing element is chosen such that the piercing element does not impede the functionality or comfort of the glasses for the wearer

Given the process by which the user is to puncture the can, the location of a piercing element will typically be chosen so as to make the puncturing process mechanically easy for the user. For example, a piercing element may be placed at the corner of the glasses frame for this reason.

In another general aspect, an apparatus includes an eyeglass frame. The eyeglass frame includes a lens holder configured to support an eyeglass lens, a temple support having a first end configured to attach to the lens holder and a second end configured to be affixed to a wearers head, and a lever-type opener. The lever-type opener is disposed at the second end of the temple support on the eyeglass frame and includes a first arm and a second arm, one of the first arm and the second arm establishing, in use, a fulcrum for the lever-type opener.

Aspects may include one or more of the following features.

The second may arm include one or more teeth. The second arm may include a plurality of teeth. A portion of the lever-type opener may be embedded in the temple support. The lever-type opener may include an elongated anchoring portion, the elongated anchoring portion being embedded in the temple support and extending along a length of the temple support. The elongated anchoring portion may include a plurality of holes. The lever-type opener may include a metallic material.

Other features and advantages of the invention are apparent from the following description, and from the claims.

### DESCRIPTION OF DRAWINGS

FIG. 1 is a perspective view of an eyeglass frame configured for quickly consuming (“shotgunning”) carbonated beverages from a can.

FIG. 2 is an enlarged view of a portion of the eyeglass frame of FIG. 1.

FIG. 3 is a side view of the eyeglass frame of FIG. 1.

FIG. 4 is a front view of an alternative embodiment of the eyeglass frame.

FIG. 5 is a side view of the eyeglass frame of FIG. 4.

FIG. 6 shows the eyeglass frame of FIG. 1 in use in consuming a carbonated beverage from a can.

FIG. 7 is a side view of an alternative embodiment of the eyeglass frame.

FIG. 8 is a side view of an opening element.

### DESCRIPTION

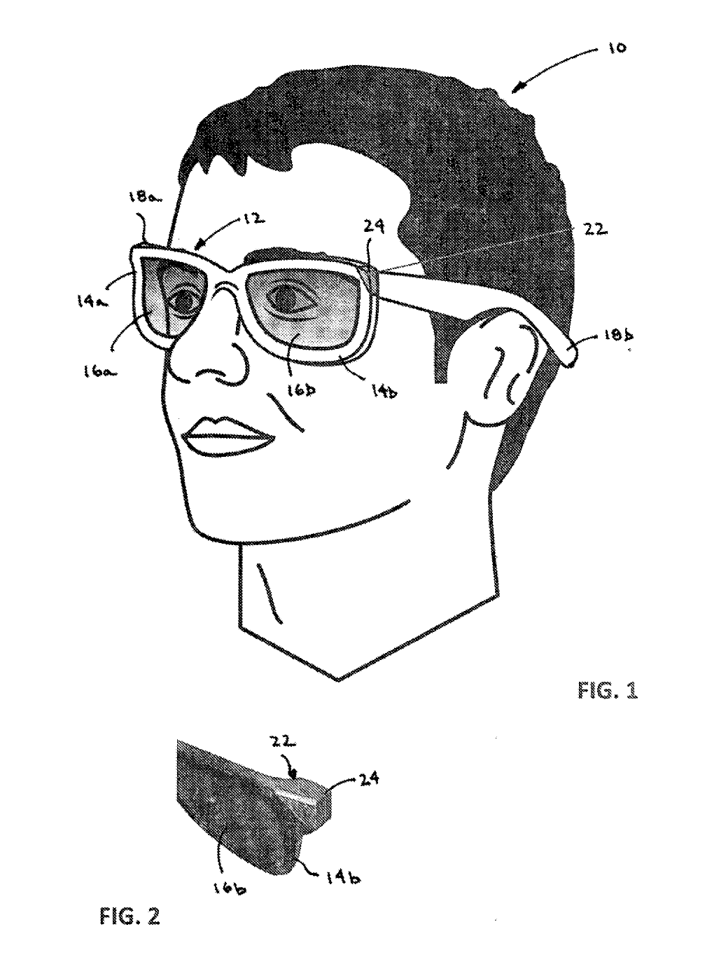

Referring to FIG. 1, a person 10 is shown to be wearing a pair of eyeglasses 12 (here, sunglasses) of the type having a pair of lens holders 14a, 14b each supporting a lens 16a, 16b. The eyeglasses 12 include a pair of temple supports 18a, 18b each of which are connected to a respective lens holder 14a, 14b with a hinge (not shown).

Referring to FIG. 2, a piercing element 22 is secured at an upper corner of lens holder 14b and proximal to the temple support 18b. Piercing element 22 is formed of metal (e.g., stainless steel, aluminum, titanium and other alloys) and has a flat triangular shape with a pronounced right angle and sharpened tip 24. The piercing element is commonly secured to the lens holder 14a, 14b with a stainless steel screw backing (not shown) that affixes the piercing element 22 to the front of the frame. This causes the piercing element 22 to be an integral part of the frame, and allows for effective piercing. In this embodiment, piercing element is formed as an integral part of lens holder 14. In other embodiments, piercing element 22 may be formed as a hardened cap member that is adhesively attached or otherwise secured to the upper corner of the lens holder 14b.

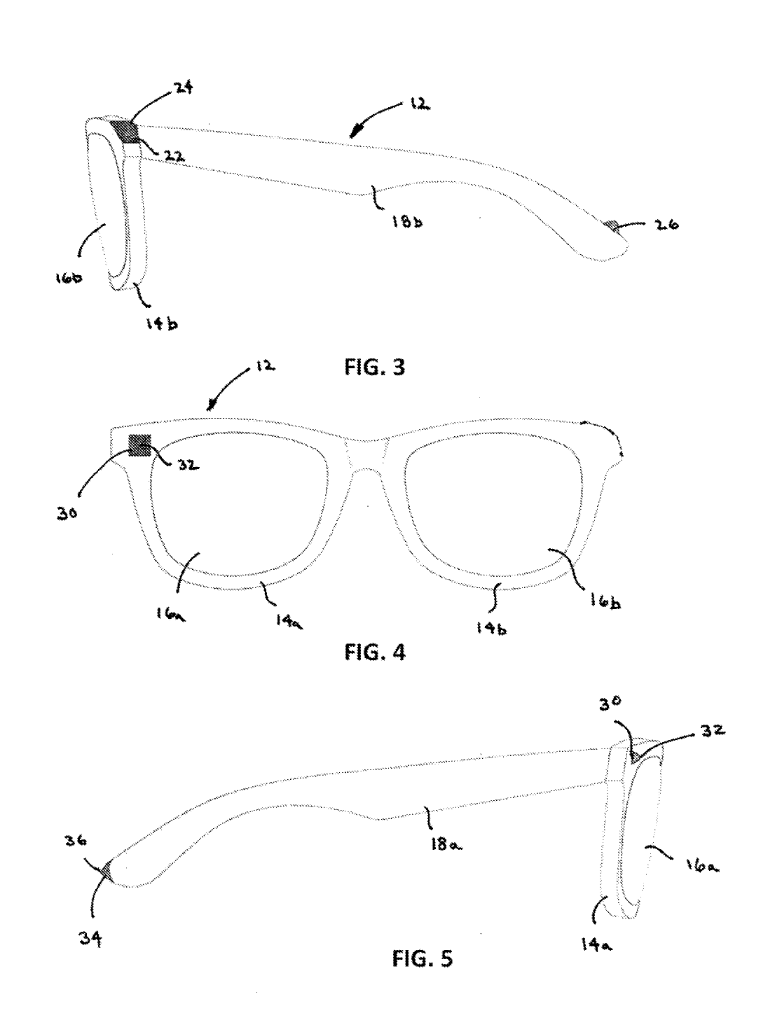

Referring to FIG. 3, in some embodiments, a second piercing element 26 is formed at a distal upper surface of temple support 18b, more particularly where the distal end of temple support 18b earpiece 17′s begins to have a nonzero radius of curvature. Piercing element 26 has a sharpened tip 28 that points upward and along an axis perpendicular to that of a longitudinal axis of temple support 18b. Piercing member 26 serves as an alternative can-puncturing mechanism for eyeglasses 12.

Referring to FIG. 4, an alternative embodiment of a pair of eyeglasses 12 include a pyramid-shaped piercing element 30 placed near the upper corner of lens holder 14a. Piercing element 30 has a sharpened tip 32 that points in a direction that is transverse to the plane of lens 16a and substantially in the direction of the person's eyesight.

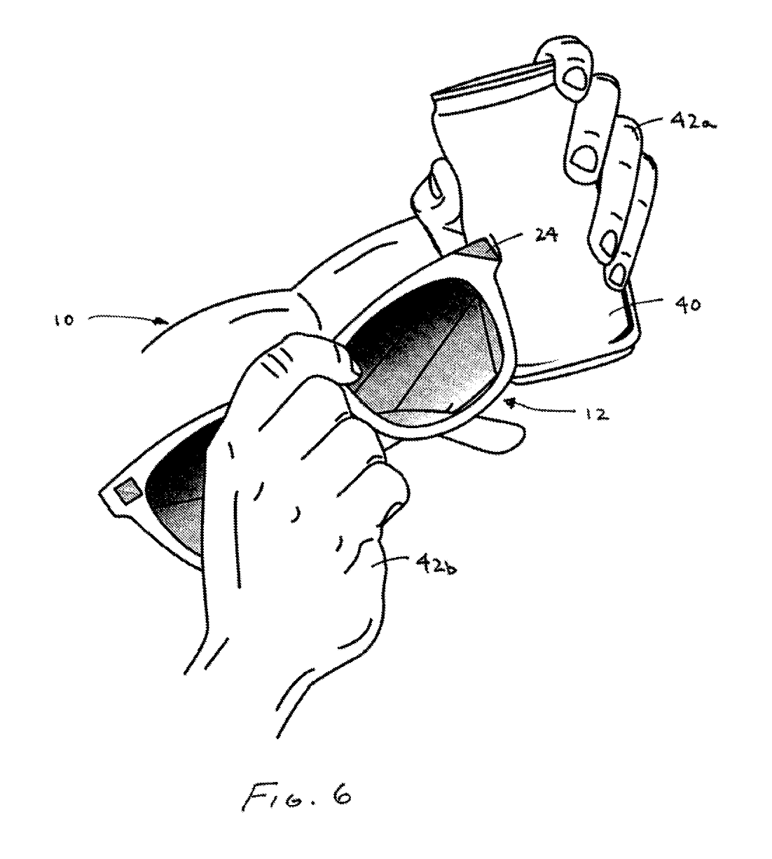

Referring to FIG. 5, in certain embodiments of the eyeglasses of FIG. 4, a piercing element 34 is located at the distal tip of temple support 18a and has a sharpened point 36 that points in a direction substantially along the longitudinal axis of temple support 18a.

Referring to FIG. 6, person 10 is shown holding a beverage can 40 in one hand 42a while holding eyeglasses 12 in the other hand 42b. The person 10 directs piercing element 24 at an angle (e.g., 45-degree) towards the bottom of can 40. When the person 10 applies pressure to eyeglasses 12 with piercing element 24, can 40 is pierced by element 24. Once a hole has been punched or punctured, the person 10 places his/her mouth over the drinking spout at the top of the can 40, the person 10 then draws suction over the punched hole while rotating the can straight up. When the ring-tab of the can is pulled or when a second opening is made at the top of the can, the liquid will quickly drain through the punched hole into the drinker's mouth.

It is to be understood that the foregoing description is intended to illustrate and not to limit the scope of the invention, which is defined by the scope of the appended claims. Other embodiments are within the scope of the following claims.

For example, the various embodiments described above in conjunction with FIGS. 1-5 illustrate piercing elements disposed at various positions along the eyeglass frame including on the lens holder and the end of a temple support. Certain embodiments may include only one piercing element while other embodiments can include more than one piercing element.

Furthermore, although FIGS. 1-5 show a piercing element fixed to a pair of eyeglasses, the piercing element can also be placed on any type of eyeglasses including sunglasses, magnifying glasses (e.g., reading glasses) etc.

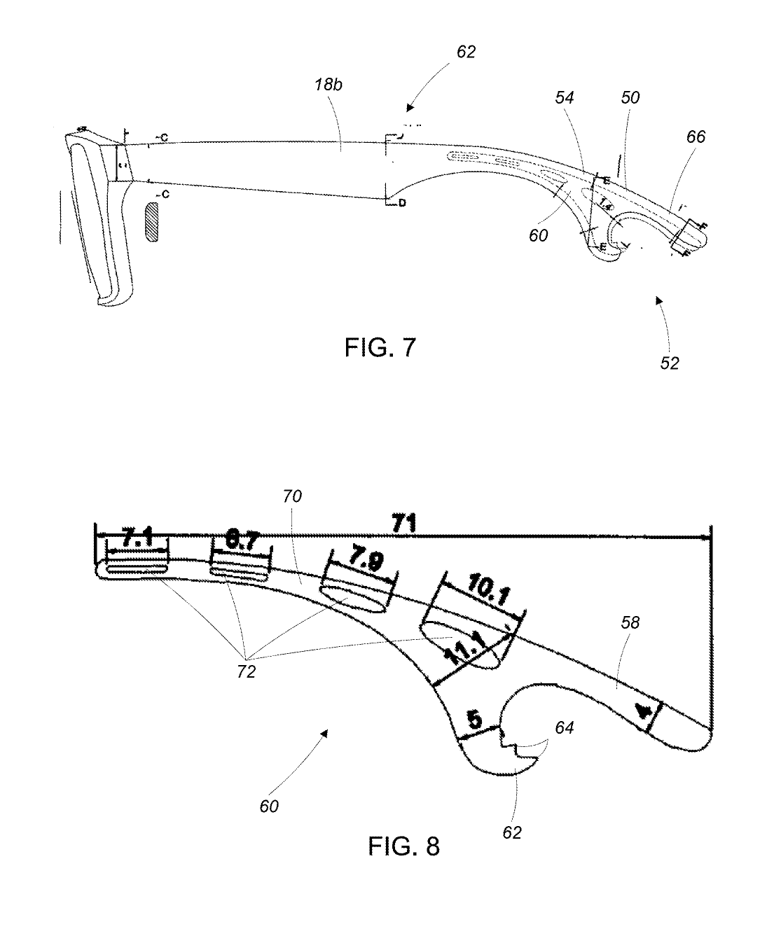

Referring to FIG. 7, in another example, a pair of eyeglasses 62 includes a lever-type opener 52 at a distal end 50 of one of the temple supports 18b. The lever-type opener 52 includes an opening element 60 that is partially embedded in a plastic end portion 54 of the temple support 18b.

Referring to FIG. 8, the opening element 60 includes an elongated arm 58, a curved arm 62 that is shorter than the elongated arm 58, and an elongated anchoring portion 70. Together, the elongated arm 58 and the curved arm 62 form a lever-type opener shape (e.g., a lever-type bottle opener shape). In some examples, the curved arm 62 includes one or more teeth 64 for gripping or piercing a surface. In some examples, the elongated anchoring portion 70 includes a number of through holes 72 through which the plastic material of the temple support 18b flows during manufacture of the eyeglasses 62. The presence of plastic material in the through holes 72 ensures that the opening element 60 is securely anchored in the plastic end portion 54 of the temple support 18b. In some examples, the opening element 60 is fabricated from a metallic material.

Referring again to FIG. 7, as is noted above, the opening element 60 is partially embedded in the plastic end portion 54 such that an edge of the elongated arm 58 and an edge of the curved arm 62 protrude from the plastic end portion 54. The elongated anchoring portion 70 extends through the temple support 18b in a direction away from the distal end 50 of the temple support 18b and prevents the opening element 60 from being pulled out of the distal end 50 of the temple support 18b.

In some examples the plastic end portion 54 of the temple support 18b has an elongated plastic arm 66 and a curved plastic arm 68 that is shorter than the elongated plastic arm 68 such that the plastic end portion 54 substantially conforms to the shape of the opening element 60.

Referring to both FIG. 7 and FIG. 8, to remove a cap from a bottle, the lever-type opener 52 is positioned on the cap with the protruding edge of the elongated arm 58 of the opening element 60 placed on a top surface of the cap and the protruding edge of the curved arm 62 of the opening element 60 engaged under a side of the cap. A user then actuates the lever-type opener 52 such that the elongated arm 58 engages a point on the top of the cap to establish a fulcrum, about which the opener 52 pivots. As the opener 52 pivots, the curved arm 62 moves in an upward direction and pries the cap from the bottle.

In some examples, the lever-type opener 52 can also be used to puncture a hole in a side of a beverage can. For example, the elongated arm 58 and the curved arm 62 of the opening element 60 can be arranged such that they engage a lip on a bottom surface of the beverage can and, by the same levering action described above, pierce the beverage can with either the elongated arm 58 or the curved arm 62. In some examples, the elongated arm 58 is configured to pierce the beverage can, resulting in a uniform piercing in the beverage can with a length of approximately 1.5 inches and a width of approximately 0.25 inches. In some examples, the length and width of the elongated arm 58 are specified to achieve a desired uniform piercing.

In some examples, the teeth 62 on the curved arm 62 are used to ensure that the opener 52 does not slip on the surface of the beverage can during the levering action. In some examples, the teeth 62 on the curved arm 62 are used to puncture the surface of the beverage can.

What is claimed is:

1. An apparatus comprising:
an eyeglass frame, including
a lens holder configured to support an eyeglass lens;
a temple support having a first end configured to attach to the lens holder and a second end configured to be affixed to a wearers head; and
a piercing member positioned on the eyeglass frame.

2. The apparatus of claim 1 wherein the piercing element is attached to the lens holder at a region proximate to an attachment region between the lens holder and temple support.

3. The apparatus of claim 1 wherein the piercing element includes a square-based pyramid shape with a point.

4. The apparatus of claim 2 wherein the piercing element includes a square-based pyramid shape with a point.

5. The apparatus of claim 1 wherein the piercing element has a triangular shape with a point.

6. The apparatus of claim 1 wherein the piercing element is attached to the lens holder at the second end of the temple support.

7. The apparatus of claim 5 wherein the piercing element is attached to the lens holder at the second end of the temple support.

8. The apparatus of claim 1 wherein the piercing element is integrally formed on the eyeglass frame.

9. A method of making eyeglasses comprising:
providing an eyeglass frame, including a lens holder configured to support an eyeglass lens, a temple support having a first end configured to attach to the lens holder and a second end configured to be affixed to a wearers head; and
attaching a piercing member on the eyeglass frame.

10. The method of claim 9 wherein attaching the piercing element includes attaching the piercing element to the lens holder at a region proximate to an attachment region between the lens holder and temple support.

11. The method of claim 9 wherein the piercing element includes a square-based pyramid shape with a point.

12. The method of claim 9 wherein the piercing element has a triangular shape with a point.

13. The method of claim 9 further comprising attaching the piercing element at the second end of the temple support.

14. The method of claim 13 wherein the piercing element has a triangular shape.

15. The method of claim 9 further comprising providing the piercing element integrally with the eyeglass frame.

16. An apparatus comprising:
an eyeglass frame, including
a lens holder configured to support an eyeglass lens;
a temple support having a first end configured to attach to the lens holder and a second end configured to be affixed to a wearers head; and
a lever-type opener disposed at the second end of the temple support on the eyeglass frame and including a first arm and a second arm, one of the first arm and the second arm, one of the first arm and the second arm establishing, in use, a fulcrum for the lever-type opener.

17. The apparatus of claim 16 wherein the second arm includes a plurality of teeth.

18. The apparatus of claim 16 wherein a portion of the lever-type opener is embedded in the temple support.

19. The apparatus of claim 18 wherein the lever-type opener includes an elongated anchoring portion, the elongated anchoring portion being embedded in the temple support, extending along a length of the temple support, and including a plurality of holes.

20. The apparatus of claim 16 wherein the lever-type opener includes a metallic material.
